(19) United States
(12) Patent Application Publication
(10) Pub. No.: US 2022/0374977 A1
(43) Pub. Date: Nov. 24, 2022

(54) SYSTEMS AND METHODS FOR GENERATING A BANKING ACTIVITY FEED

(71) Applicant: Wells Fargo Bank, N.A., San Francisco, CA (US)

(72) Inventor: James P. Smith, San Francisco, CA (US)

(21) Appl. No.: 14/495,477

(22) Filed: Sep. 24, 2014

Related U.S. Application Data
(60) Provisional application No. 61/883,773, filed on Sep. 27, 2013.

(51) Int. Cl. G06Q 40/00; H04L 29/08

(52) U.S. Cl. CPC G06Q 40/00; H04L 67/306

(57) ABSTRACT

A banking activity feed is generated for a client device. Processing is performed in connection with a plurality of accounts of an account holder. Based on the processing, activity items are generated comprising information regarding activity occurring in connection with the plurality of accounts. An activity feed is generated that comprises a list of the activity items from the plurality of accounts. The activity feed is displayed to a user via the client device.

### CROSS-REFERENCE TO RELATED APPLICATIONS

This application claims the benefit of priority to U.S. Provisional Application No. 61/883,773, filed Sep. 27, 2013, entitled “Systems and Methods for Generating a Banking Activity Feed”, which is incorporated by reference herein in its entirety.

### BACKGROUND

The present disclosure generally relates to systems and methods for communicating financial information to a user via a client device. More specifically, the present disclosure relates to systems and methods for providing a user with information regarding recent bank account transactions and other events via a client device such as a mobile phone.

### SUMMARY

According to an example embodiment, a banking activity feed is generated for a client device. Processing is performed in connection with a plurality of accounts of an account holder. Based on the processing, activity items are generated comprising information regarding activity occurring in connection with the plurality of accounts. An activity feed is generated that comprises a list of the activity items from the plurality of accounts. The activity feed is displayed to a user via the client device.

### BRIEF DESCRIPTION OF THE DRAWINGS

FIG. 1 illustrates a computer architecture, in accordance with a described implementation;

FIG. 2 illustrates an example user interface displaying an activity feed, in accordance with a described implementation;

FIG. 3 illustrates an example user interface displaying various options for the activity feed, in accordance with a described implementation;

FIG. 4 illustrates an example interface for configuring time periods to which items in an activity feed pertain, in accordance with a described implementation;

FIGS. 5A-5B illustrates an example interface for configuring the activity feed, in accordance with a described implementation; and

FIG. 6 is a flow chart of a method for generating a list of activity items for a banking activity feed; in accordance with a described implementation.

### DETAILED DESCRIPTION

According to example embodiments, systems and methods disclosed herein generate an activity feed showing recent banking activity and provide the activity feed to a client device for display to a user. In various example embodiments, the activity feed may include transactions or other events that occurred in the past, as well as events that are scheduled to occur in the future, such as payment due dates. The user may be provided with the flexibility to configure the types of events that are included in the activity feed. Each item listed in the activity feed may include an indication of a product name (e.g., a checking account, credit card, etc.), a description of the activity (e.g., transaction description, payment due, etc.), a time frame (e.g., date and time) associated with the activity, a call to action (e.g., a link labeled “pay now,” “view details,” etc.), and/or other information. The user may also be given the option to take other actions relative to the listed activities, such as to flag them for later follow-up, share them with other individuals, and so on.

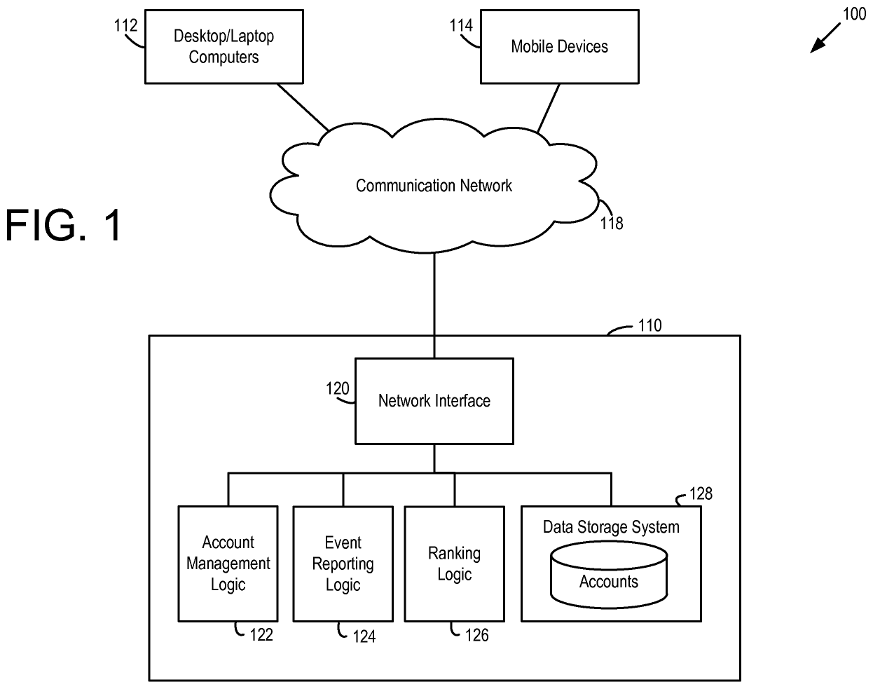

Referring first to FIG. 1, FIG. 1 shows a data processing system 100 that may be used to implement the systems and methods described herein according to an example embodiment. The data processing system 100 includes a bank computer 110 that may be configured to maintain bank accounts held by account holders. For example, the bank computer 110 may comprise a system of interconnected servers that, for example, execute stored program instructions to implement the operations described herein. Users (e.g., account holders) may access the system 110 to receive account information using a variety of client devices 112, 114. The client devices 112, 114 may include laptop computers, desktop computers, mobile computing devices (e.g., cell phones, tablets, mobile e-mail devices, and so on). The client devices 112, 114 may access the system 100 through a communication network 118 which may, for example, include the Internet, telephone networks, wireless networks, point-to-point networks, and/or other networks.

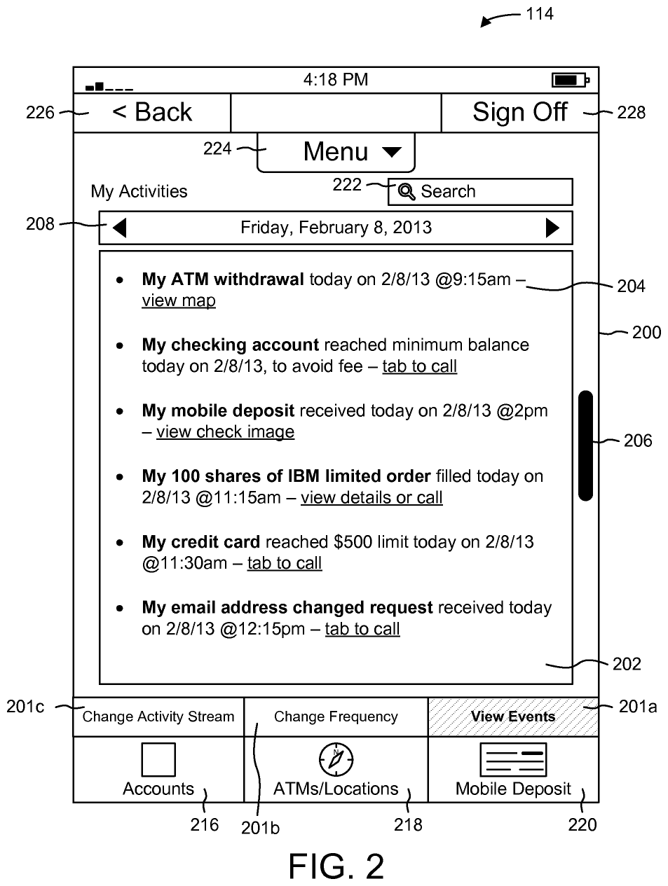

Bank computer 110 may include network interface logic 120, account management logic 122, event reporting logic 124, ranking logic 126 and data storage system 128. Network interface logic 120 may be used to establish connections with client devices 112, 114 and to permit users to access accounts in system 110 by way of network 118. For example, in the context of desktop/laptop computers, network interface logic 120 may comprise one or more web servers that provide a graphical user interface (e.g., a series of dynamically-generated web pages) for users that access system 110 through the web. For mobile devices such as cell phones, network interface logic 120 may comprise servers that provide a user interface accessible as a mobile website or via an application executing on the client device. An example of a user interface provided via a client device is described in greater detail below in connection with FIGS. 2-5.

The account management logic 122 performs account processing to process transactions in connection with the accounts of the account holders, such as account debits and credits to checking and savings accounts, credits and debits to home mortgage and home equity accounts, credits and debits to student loan accounts, and so on. For example, in the context of checking accounts, the transactions may also include electronic bill payment transactions in which monies from the checking account of the user are used to pay bills received by the user. The account management logic 122 may also be configured to perform processing in connection with other activities associated with the servicing and maintenance of the accounts of the account holders. The account management logic 122 may access and update information stored in the data storage system 128, which stores details regarding financial institution accounts including information for each financial transaction that occurred.

Event reporting logic 124 generates reports for the user relating to the user's account(s). For example, reporting logic 124 may be configured to generate monthly statements for debit accounts and credit card accounts. In an example embodiment, reporting logic 124 is further configured to generate an activity feed showing recent banking activity and provide the activity feed to a client device for display to a user. The activity feed may contain information about various types of activities relating to accounts of the account holders. The activity feed may be generated using information obtained by the account management logic 124 in during processing in connection with the accounts of the account holders (e.g., transaction processing and other service and maintenance).

The activity feed may contain different types of items, such as information about out-of-pattern activities, money movement activities, notifications and alerts, and service request updates. The activities may occur in different channels, such as ATM, store, mobile, phone, and so on. The items in the activity feed may relate to various accounts held by the account holder (e.g., checking, savings, retirement, etc.).

For example, Table 1 below lists examples of out-of-pattern activities items that may be included in an activity feed for purposes of preventing fraud (e.g., because such activities are deemed unusual and therefore potentially fraudulent).

TABLE 1
OUT-OF-PATTERN ACTIVITIES

| Type of Activity | Feed Purpose |
|---|---|
| Logon from an unfamiliar device or location | Fraud prevention |
| Change of logon, password (device, channel, location) | Fraud prevention |
| Usage of credit card/debit card/ATM in an | Fraud prevention |
| unusual location | |
| Unusual # of failed attempts to logon | Fraud prevention |
| Change of customer profile and contact information | Fraud prevention |
| Change of notification/alerts delivery | Fraud prevention |
| VOD activities | Fraud prevention |

As another example, Table 2 below lists examples of money movement activities that may be included in an activity feed for purposes of preventing fraud.

TABLE 2
INTRA-DAY MONEY MOVEMENT ACTIVITIES

| Type of Activity | Feed Purpose |
|---|---|
| Withdrawal, deposits | Fraud prevention |
| Transfers | Fraud prevention |
| Wire (domestic and international) | Fraud prevention |
| Bill Pay | Fraud prevention |
| Payment activities | Fraud prevention |
| ACH Fraud Prevention | Fraud prevention |
| Mobile deposit captures | Fraud prevention |
| Purchases (via credit/debit/ATM) | Fraud prevention |

As another example, Table 3 below lists examples of notifications and alerts that may be included in an activity feed for purposes of providing reminders.

TABLE 3
NOTIFICATIONS/ALERTS

| Type of Activity | Feed Purpose |
|---|---|
| Payment due (cards, mortgage, credit accounts) | Reminder |
| CD maturity (renewal) | Reminder |
| Overdraft/insufficient funds | Reminder |
| Low balance - avoid maintenance fees | Reminder |
| Stock alerts (parameters defined by customer) | Reminder |
| Appointment reminder | Reminder |
| Readiness of the latest month e-statement | Reminder |
| Upcoming store holidays | Service Alert |
| Service alerts/interruptions | Service Alert |
| Inactive accounts | Reminder |
| Newly enrolled/Un-enrolled products and services | Reminder |
| Deposit check (confirmation and view check) | Reminder |
| Incomplete Application (action required) | Reminder |

As another example, Table 4 below lists examples of service requests that may be included in an activity feed for purposes of providing the users with status updates.

TABLE 4
SERVICE REQUEST STATUS/REPORTED ACTIVITIES

| Type of Activity | Feed Purpose |
|---|---|
| Check orders | Status Update |
| Card issue/reissue | Status Update |
| Wire | Status Update |
| Fee reimbursement | Status Update |
| Stop payment | Status Update |
| Loss/stolen of cards/checks | Status Update |
| Fraud | Status Update |
| Overdraft protection | Status Update |
| Loan/LOC/Credit application status | Status Update |
| Other product application status | Status Update |

As will be appreciated, Tables 1-4 are provided only by way of example of items that could be included in the activity feed. Fewer, more, and/or different activity items may be included in an activity feed. Also, as described in greater detail below, the user may be provided with the ability to configure which items are included in the activity feed. For example, the user may be provided with the ability to select only specific ones of the activities listed in Tables 1-4 to include in the activity feed.

Ranking logic 126 may be accessed by the event reporting logic 124 to determine the ranking of the activity items in the activity feed. For example, the items in the activity feed may be ranked in chronological order, such that the most recently generated activity items are presented at the top of the list, whereas activity items that are older are presented further down the list (potentially, requiring the user to scroll down the list). As another example, the items in the activity feed may be ranked based on perceived order of importance/urgency, such that the most important/urgent activity items are presented at the top of the list, whereas activity items that are less important/urgent are presented further down the list (potentially, requiring the user to scroll down the list). For example, payment due dates occurring in the very near future may be presented closer to the top of the activity feed than payment due dates occurring in the more distant future. As another example, a large dollar amount transaction that is considered highly likely to be fraudulent may trigger a fraud alert that is presented at the top of the activity feed, whereas a lower dollar value transaction that is considered less likely to be fraudulent may trigger a fraud alert, but the fraud alert may be presented further down on the activity feed. In one embodiment, in order to rank the activity items, the ranking logic 126 may assign a score to each activity item that is configured to reflect how important/urgent the activity item is to a particular user. For example, for any given type of activity item, a formula may be constructed which produces an output score based on a weighted summation of inputs considered predictive in assessing the importance/urgency of the activity item to the user. A score may thus be generated for each activity item and compared with the scores generated for the other activity items to rank the activity items for presentation to the user. Those items with the highest scores may then be presented at the top of the activity feed.

Referring now to FIG. 2, FIG. 2 illustrates an example user interface 200 displaying an activity feed, in accordance with a described implementation. As will be appreciated, in one embodiment, the activity feed may be provided in the context of a mobile application executing on a client device. In other embodiments, the activity feed may be provided via a browser application. For purposes of providing an example, it will be assumed herein that the activity feed is provided in the context of a mobile application.

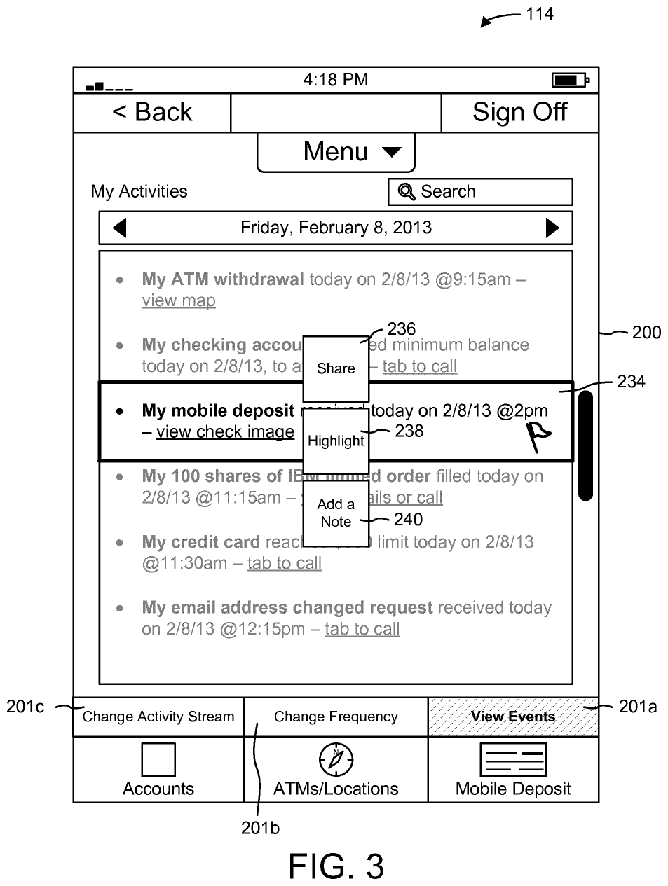

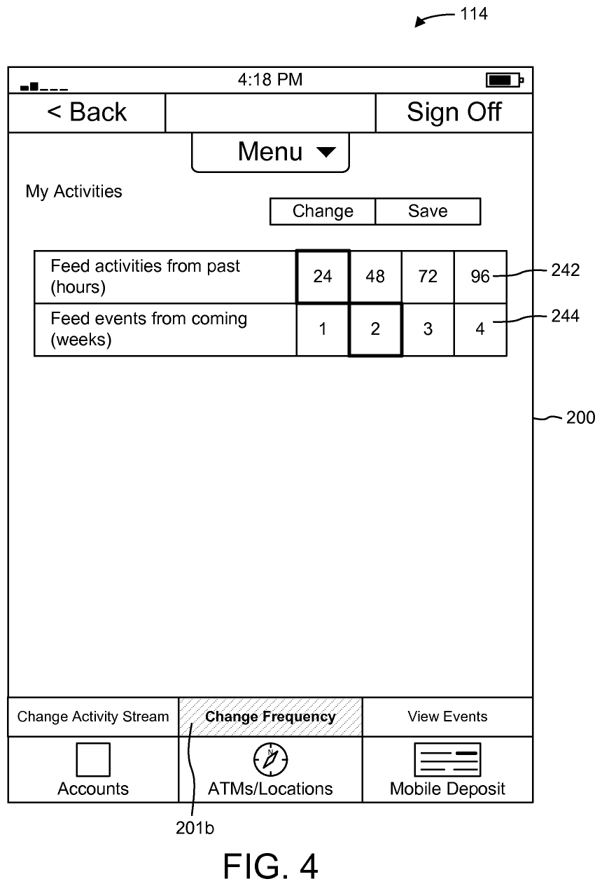

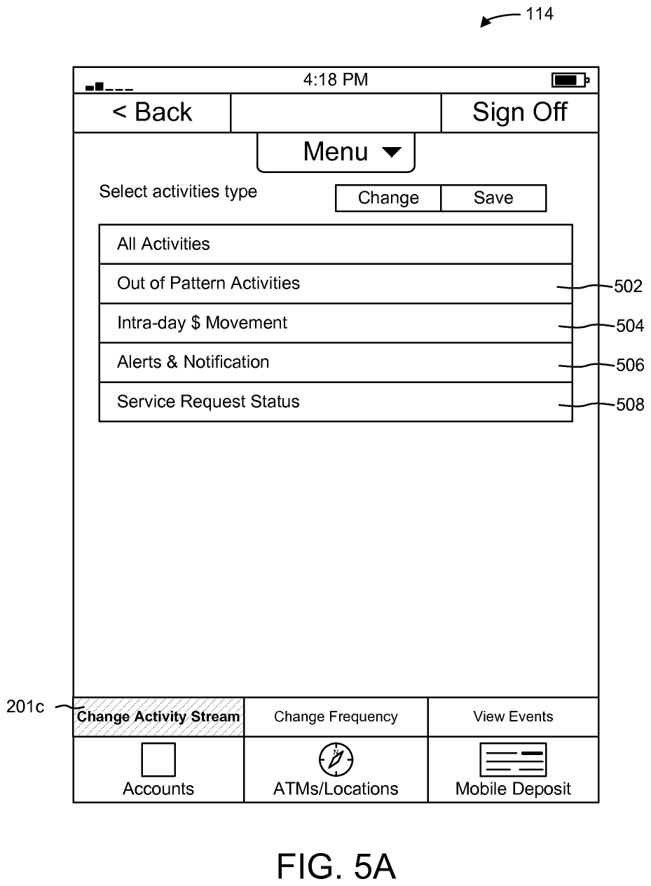

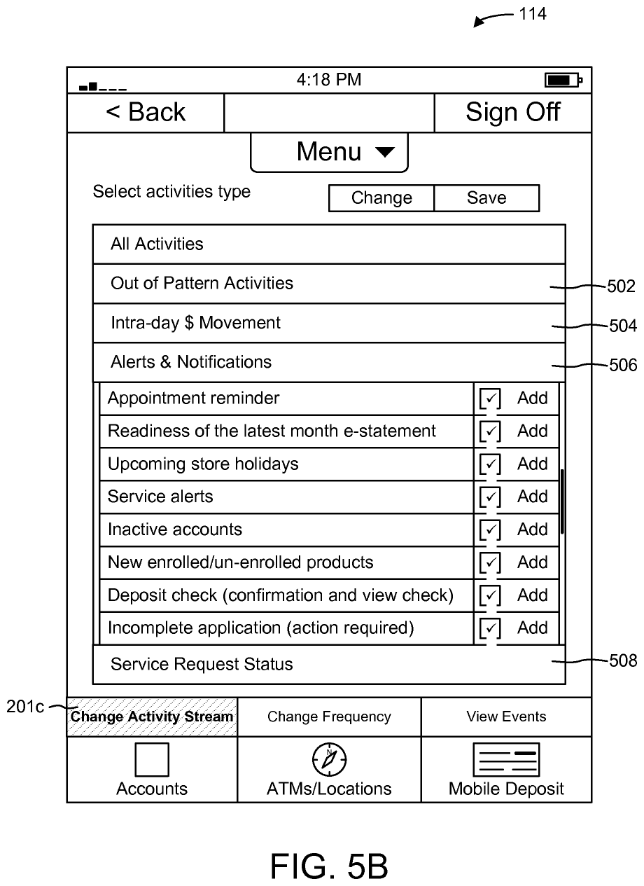

In the arrangement of FIG. 2, an application is shown in which the user has the options of selecting menu tabs 201a, 201b and 201c. If menu tab 201a is selected, then the user is presented with an activity feed as shown in FIGS. 2 and 3. If menu tab 201b is selected, then the user is provided with the opportunity to configure the time periods to which items in the activity feed pertain, as described in greater detail below in connection with FIG. 4. If menu tab 201c is selected, then the user is provided with the opportunity to configure the activity items contained in the activity feed, as described in greater detail below in connection with FIGS. 5A-5B.

Referring first to FIG. 2, FIG. 2 shows an example of an activity feed. In the example of FIG. 2, the activity consumes a substantial majority of a display of the client device of the user. Each item listed in the activity feed may include an indication of a product name (e.g., a checking account, credit card, retirement account, etc.), a description of the activity (e.g., transaction description, payment due, etc.), a date/time associated with the event, and a call to action (e.g., a link labeled “pay now,” “view details,” etc.). For example, example 204 shows an event item (ATM withdrawal on Feb. 8, 2013 at 9:15 a.m.) along with a call to action (“view map”). The call to action may be provided in the form of a hyperlink that allows a user to interact with the activity feed to obtain additional information or perform follow-up in connection with the listed activity item. If the hyperlink is selected, additional data regarding the event may be shown to the user. The additional data may include comments, audio data, video data, multimedia data, etc. The hyperlink may provide additional information about the activity or the event by providing an overlay to the activity feed 202 or an expansion to the event 204 within the activity feed 202. For example, in the context of an ATM withdrawal, the call to action (“view map”) may provide the user with the ability to see the location where the ATM transaction occurred if the user does not recall making the particular ATM withdrawal. Viewing the location where the withdrawal occurred may refresh the user's memory as to the ATM withdrawal or, alternatively, if the location of the ATM withdrawal is unfamiliar to the user, may provide an indication that the ATM withdrawal was fraudulently performed by another individual.

A user may cause the activity feed to scroll up or down using scroll bar 206 or by engaging activity feed 202. In some implementations, the user may zoom in/out by engaging activity feed 202. Field 208 indicates the time period to which items in the activity feed 202 pertain. For example, field 208 may indicate the day on which the items in the activity feed 202 were generated. In various embodiments, the user is be provided with the ability to scroll through the activity feed 202 to view activity items from other days.

Other features may be present on display 200, such as components 222, 224, 226, and 228. Component 222 is a search field that allows a user to search for the activity item associated with an event. Component 224 may be engaged to display the menu that may be selected, which may direct away from the activity feed 202. For example, if component 224 is selected, the display of the client device 114 may show security options, bill pay, customer service, etc. as a separate display, rather than on the activity feed 202. Component 226 is a back option, while component 228 is a sign off feature.

Referring now to FIG. 3, the user may also be given the option to take other actions relative to the listed activities, such as to flag them for later follow-up, share them with another individual, and so on. In the example of FIG. 3, one of the items 234 is selected. The selection of a particular item may cause the display of the selected item to differ from the rest of the activity feed 202, such as by highlighting, bolding, etc. In FIG. 3, the selection of item 234 also causes additional options of share 236, highlight 238, or add a note 240 to be displayed. Fewer, additional or different options may also be displayed. Option 236 allows item 234 to be shared with another client device (e.g., the client device of a spouse), a web site (e.g., a social networking site), and so on.

Option 238 allows item 234 to be highlighted, e.g., flagged for future follow-up. This makes the display of activity feed 202 easier to navigate and to organize. As another example, item 234 can be highlighted along with other items. In some embodiments, all of the highlighted items may then be selected to perform an additional task, such as exporting all highlighted items to a spreadsheet for future accessibility.

Option 240 allows a note to be added to item 234. In some implementations, the note may include a date, which automatically places item 234 in a calendar. As another example, in some embodiments, if the item is an expense, such as a credit card transaction, the user may annotate the credit card transaction to facilitate later inclusion of the expense in an expense report.

Referring now to FIG. 4, FIG. 4 illustrates an example interface for configuring the time periods to which items in the activity feed pertain, in accordance with a described implementation. Fields 242 and 244 permit the user to select a forward looking time period and a rearward looking time period. Activities occurring in the future must be within the forward looking time period in order to be included in the activity feed and activities occurring in the past must be within the rearward looking time period in order to be included in the activity feed. Specifically, in field 242, the user has the option to configure time periods associated with activity items from the past, such as recent transactions. For example, in the example shown, the user has configured the activity feed 202 to display activity items from the past twenty-four hours. In field 244, the user has the option to configure time periods associated with activity items associated with the future, such as upcoming payment due dates. For example, in the example shown, the user has configured the activity feed 202 to display activity items for the next two weeks.

Referring now to FIGS. 5A and 5B, FIGS. 5A and 5B illustrates an example interface for configuring the types of activities that appear in the activity feed 202. Referring first to FIG. 5A, in FIG. 5A the user is presented with an option 502 to configure whether/which any “out of pattern” activity items are to be displayed, an option 504 to configure whether/which any “intra-day money movement” activity items are to be displayed, an option 506 to configure whether/which any “alerts & notifications” activity items are to be displayed, and an option 508 to configure whether/which any “service request status” activity items are to be displayed. Tables 1-4 (described previously) provide additional details regarding activity items that may be displayed within each of these categories. In FIG. 5B, the user has selected option 506 (“alerts & notifications”), and is provided with further options to select which types of alerts and notifications are to appear in the activity feed 202.

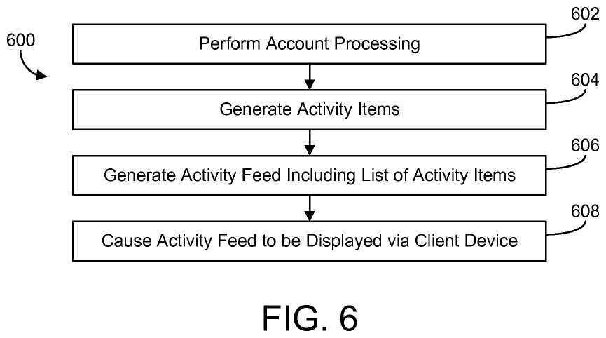

FIG. 6 is an example method 600 for generating a list of activity items for a banking activity feed, in accordance with a described implementation. Example method 600 may be performed by architecture 100 or other systems. In some implementations, example method 600 may be performed at least partially offline.

At step 602, processing is performed in connection with a plurality of accounts of an account holder. Such processing may be performed, for example, by the account management logic 122, as previously described in connection with FIG. 1. At step 604, activity items are generated for the activity feed. For example, the activity items may be generated by the event reporting logic, as previously described in connection with FIG. 1. The activity items comprise information regarding activity occurring in connection with the plurality of accounts. At step 606, the activity items are combined in a list to generate the activity feed. As previously indicated, the activity items may be listed in chronological order, in order of perceived importance, or in another manner. At step 608, the bank computer 110 causes the activity feed to be displayed to a user via a client device. For example, the bank computer 110 may transmit the activity to the client device, causing the activity feed to be displayed.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. The present embodiments contemplate methods, systems and program products on any machine-readable media for accomplishing its operations. The embodiments of may be implemented using an existing computer processor, or by a special purpose computer processor incorporated for this or another purpose or by a hardwired system.

As noted above, embodiments within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, logic, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method of presenting information regarding a financial account, the method comprising:
generating an activity feed including one or more activity items comprising information regarding financial transaction activity occurring in connection with a financial account of a user and information regarding potentially fraudulent activities, the potentially fraudulent activities comprising an out-of-pattern activity;
generating an importance score for each of the one or more activity items based on a payment due date, a transaction amount, and inputs predictive in assessing the urgency of the one or more activity items;
ranking the one or more activity items of the activity feed based on the importance score;
transmitting, to a client device, and in response to a request from a user for information regarding financial transaction activity occurring in connection with the financial account and information regarding potentially fraudulent activities, a graphical user interface displayable by the client device;
displaying, within the graphical user interface, the activity feed, wherein the one or more activity items are ordered in the activity feed based on a corresponding rank and wherein the activity feed includes both activity items describing financial transaction activity occurring in the future and activity items describing financial transaction activity occurring in the past;
displaying, concurrently with the displaying of the activity feed within the graphical user interface and in response to a user selection of a first activity item from the activity feed, a plurality of discrete user selectable windows within the graphical user interface; and
initiating, in response to a user selection of one of the user selectable windows and while the activity feed is being displayed within the graphical user interface, an action relative to the first activity item, each of the displayed user selectable windows being functionally linked to the first activity item and configured to effectuate a different action relative to the first activity item upon selection by the user;
wherein the user selectable windows displayed within the graphical user interface responsive to the user selection of the first activity item overlay the activity feed and are arranged relative to one another within the graphical user interface such that the activity feed remains partially visible within portions of the graphical user interface extending between adjacent user selectable windows.

2-3. (canceled)

4. The method of claim 1, further comprising displaying, for each of the activity items displayed in the graphical user interface, a call to action comprising a link that may be selected by the user to obtain additional information about the activity item associated with the displayed call to action.

5. (canceled)

6. The method of claim 1, further comprising receiving, via a second graphical user interface a user input indicative of one or more selected various types of out-of-pattern activities to be included in the activity feed.

7. The method of claim 1, further comprising receiving, via a second graphical user interface a user input indicative of one or more selected various types of money movement activities to be included in the activity feed.

8. The method of claim 1, further comprising receiving, via a second graphical user interface a user input indicative of one or more selected various types of notifications and alerts to be included in the activity feed.

9. (canceled)

10. The method of claim 1, further comprising receiving, via a second graphical user interface a user input indicative of a forward looking time period and a user input indicative of a rearward looking time period, wherein a financial transaction activity item occurring in the future must be within the forward looking time period in order to be included in the activity feed and a financial transaction activity item occurring in the past must be within the rearward looking time period in order to be included in the activity feed.

11. The method of claim 1, wherein the activity feed consumes a substantial majority of a display of the client device.

12. A non-transitory computer readable storage medium storing one or more programs that, when executed by a computer, cause the computer to:
generate an activity feed including one or more activity items comprising information regarding financial transaction activity occurring in connection with a financial account of a user and information regarding potentially fraudulent activities, the potentially fraudulent activities comprising an out-of-pattern activity;
generate an importance score for each of the one or more activity items based on a payment due date, a transaction amount, and inputs predictive in assessing the urgency of the one or more activity items;
rank the one or more activity items of the activity feed based on the importance score;
transmit to a client device, and in response to a request for information regarding financial transaction activity occurring in connection with the financial account and information regarding potentially fraudulent activities, a graphical user interface displaying the activity feed;
display, within the graphical user interface, the activity feed, wherein the one or more activity items are ordered in the activity feed based on a corresponding rank and wherein the activity feed includes both activity items describing financial transaction activity occurring in the future and activity items describing financial transaction activity occurring in the past;
display, concurrently with the display of the activity feed within the graphical user interface and in response to a user selection of a first activity item from the activity feed, a plurality of discrete user selectable windows within the graphical user interface; and
initiate, in response to a user selection of one of the user selectable windows displayed responsive to the user selection of the first activity item and while the activity feed is displayed within the graphical user interface, an action relative to the first activity item, each of the displayed user selectable windows being functionally linked to the first activity item and configured to effectuate a different action relative to the first activity item upon selection by the user;
wherein the user selectable windows displayed within the graphical user interface responsive to the user selection of the first activity item overlay the activity feed and are arranged relative to one another within the graphical user interface such that the activity feed remains partially visible within portions of the graphical user interface extending between adjacent user selectable windows.

13-14. (canceled)

15. The non-transitory computer readable storage medium of claim 12, wherein the medium is further configured to cause the computer to display, for each of the activity items displayed in the graphical user interface, a call to action comprising a link that may be selected by the user to obtain additional information about the activity item associated with the displayed call to action.

16. (canceled)

17. The non-transitory computer readable storage medium of claim 12, wherein the medium is further configured to cause the computer to receive, via a second graphical user interface a user input indicative of one or more selected various types of out-of-pattern activities to be included in the activity feed.

18. The non-transitory computer readable storage medium of claim 12, wherein the medium is further configured to cause the computer to receive, via a second graphical user interface a user input indicative of one or more selected various types of money movement activities to be included in the activity feed.

19. The non-transitory computer readable storage medium of claim 12, wherein the medium is further configured to cause the computer to receive, via a second graphical user interface a user input indicative of one or more selected various types of notifications and alerts to be included in the activity feed.

20-21. (canceled)

22. The non-transitory computer readable storage medium of claim 12, wherein the activity feed consumes a substantial majority of a display of the client device.

23. A computer-implemented method comprising:
displaying, in response to a request for information regarding financial transaction activity from a user and within a graphical user interface displayed by a client device, an activity feed including one or more activity items corresponding to financial transaction activity occurring in connection with at least one financial account of the user to the user and information regarding potentially fraudulent activities, the potentially fraudulent activities comprising an out-of-pattern activity, wherein the activity feed includes both activity items describing financial transaction activity occurring in the future and activity items describing financial transaction activity occurring in the past, wherein the one or more activities are ranked based on an importance score associated with each of the one or more activities and based on a payment due date, a transaction amount, and inputs predictive in assessing the urgency of the one or more activity items, and wherein the one or more activities are ordered in the activity feed based on a corresponding rank;
displaying, while the graphical user interface continues to display the activity feed and in response to a user selection of a first activity item from the activity feed, a plurality of discrete user selectable windows within the graphical user interface; and
initiating, in response to a user selection of one of the user selectable windows displayed responsive to the user selection of the first activity item and while the activity feed is being displayed within the graphical user interface, an action relative to the first activity item, each of the displayed user selectable windows being functionally linked to the first activity item and configured to effectuate a different action relative to the first activity item upon selection by the user;
wherein the user selectable windows displayed within the graphical user interface responsive to the user selection of the first activity item overlay the activity feed and are arranged relative to one another within the graphical user interface such that the activity feed remains partially visible within portions of the graphical user interface extending between adjacent user selectable windows.

24-25. (canceled)

26. The method of claim 23, further comprising displaying, for each of the activity items displayed in the graphical user interface, a call to action comprising a link that may be selected by the user to obtain additional information about the activity item associated with the displayed call to action.

27. (canceled)

28. The method of claim 23, further comprising receiving, via a second graphical user interface a user input indicative of one or more selected various types of out-of-pattern activities to be included in the activity feed.

29. The method of claim 23, further comprising receiving, via a second graphical user interface a user input indicative of one or more selected various types of money movement activities to be included in the activity feed.

30. The method of claim 23, further comprising receiving, via a second graphical user interface a user input indicative of one or more selected various types of notifications and alerts to be included in the activity feed.

31-32. (canceled)

33. The method of claim 23, wherein the activity feed consumes a substantial majority of a display of the client device.

34-37. (canceled)

38. The method of claim 4, further comprising displaying an overlay in the graphical user interface in response to receiving a user selection of the link for the call to action associated with one of the activity items of the activity feed, wherein the additional information about the activity item associated with the selected call to action link is displayed in the overlay.

39. The method of claim 4, further comprising expanding a size of an entry corresponding to an activity item of the activity feed displayed in the graphical user interface in response to receiving a user selection of the link for the call to action associated with one of the activity items of the activity feed, wherein the additional information about the activity item associated with the selected call to action link is displayed in the expanded activity item entry of the activity feed.

40. The method of claim 1, further comprising visually differentiating the user selected first activity item from the other activity items in the activity feed while the plurality of user selectable windows are displayed.

41. The method of claim 1, further comprising sharing the selected first activity item with at least one of another client device and a web site in response to a user selection of a selectable window configured to share an activity item.

42. The method of claim 1, further comprising highlighting the selected first activity item in the activity feed in response to a user selection of a selectable window configured to highlight an activity item.

43. The method of claim 42, further comprising highlighting a selected second activity item in the activity feed in response to a user selection of the selectable window configured to highlight an activity item, wherein each of the first activity item and second activity item are highlighted in the activity feed following a user selection of the selectable window configured to highlight an activity item displayed in response to the user selection of the second activity item.

44. The method of claim 43, wherein the highlighted first activity item and second activity items in the activity feed may be selected by the user to perform an additional task.

45. The method of claim 43, wherein the highlighted first activity item and second activity items in the activity feed may be selected by the user to be exported to a spreadsheet.

46. The method of claim 1, further comprising adding a note to the selected first activity item in response to a user selection of a selectable window configured to add a note to an activity item.

47. The method of claim 46, further comprising adding the first activity item into a calendar in response to a user adding a note comprising a date to the selected first activity item.

48. The method of claim 1, further comprising displaying, in response to a user selection of a second activity item from the activity feed, the plurality of discrete user selectable windows; and
effectuating, in response to a user selection of a user selectable window, an action relative to the second activity item selected by the user.
